(19) United States
(12) Patent Application Publication
(10) Pub. No.: US 2008/0271030 A1
(43) Pub. Date: Oct. 30, 2008

(54) Kernel-Based Workload Management

(76) Inventor: Dan Herington, Dallas, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/742,527

(22) Filed: Apr. 30, 2007

(51) Int. Cl. G06F 9/46

(52) U.S. Cl. 718/104

(57) ABSTRACT

A method for managing workload in a computing system comprises performing automated workload management arbitration for a plurality of workloads executing on the computing system, and initiating the automated workload management arbitration from a process scheduler in a kernel.

### BACKGROUND

Workload management tools run as user space processes that wake up, typically at regular intervals, to reallocate resources among various workloads. Interrupt-driven workload processing introduces a delay in reaction to a short term spike in load to an application and also limits the types of metrics that can be used to indicate proper priority among workloads.

A user of a typical workload management tool or global workload manager generally sets the wake up intervals for the tool. The user will sometimes set the interval to the smallest limit value, for example one second, to enable the workload management tool to respond quickly to a rapid increase or spike in load. Thus, the workload management tool, operative as user space daemons, wake up at the set interval, analyze the instantaneous situation at the sampling time, and then reallocate resources between workloads by reconfiguring kernel scheduling. Unfortunately, a common occurrence is that the selected wakeup interval is insufficient for a change in scheduling to impact the workload in a way that is detectable in user space before the next set of measurements are acquired. A common result is inappropriate and unwarranted dramatic fluctuation in allocation between intervals.

The problem is addressed by increasing the amount of resources for the workloads, or limiting the number of workloads serviced by the resource set, and decreasing the frequency of wakeup intervals. Increasing the resource amount ensures more resource availability to address a spike in load, thereby reducing the need for short intervals, but results in wasted resources.

### SUMMARY

An embodiment of a method for managing workload in a computing system comprises performing automated workload management arbitration for a plurality of workloads executing on the computing system, and initiating the automated workload management arbitration from a process scheduler in a kernel.

### BRIEF DESCRIPTION OF THE DRAWINGS

Embodiments of the invention relating to both structure and method of operation may best be understood by referring to the following description and accompanying drawings:

FIG. 1A is a schematic block diagram depicting an embodiment of a computing system that performs kernel-based workload management;

FIG. 1B is a schematic process flow diagram showing data structures and data flow of an embodiment of a workload management arbitrator; and

FIGS. 2A through 2C are flow charts illustrating one or more embodiments or aspects of a method for managing workload in a computing system.

### DETAILED DESCRIPTION

Performance of workload management can be improved by executing workload management functionality in the kernel in cooperation with process scheduling.

A workload management arbitration process is relocated into the process scheduler in the kernel, thereby enabling near-instantaneous adjustment of processor resource entitlements.

Arbitration of processor or central processing unit (CPU) resource allocation between workloads is moved into a process scheduler in the kernel, effectively adding an algorithm or set of algorithms to the kernel-based process scheduler. The added algorithms use workload management information in addition to the existing run queue and process priority information for determining which processes to run next on each CPU.

The kernel runs inside the operating system, so that workload management functionality in the kernel applies to multiple workloads in a single operating system image using resource partitioning. In an illustrative system, process scheduler-based workload management calls out to a global arbiter to do the movement of resources between separate operating system-type partitions.

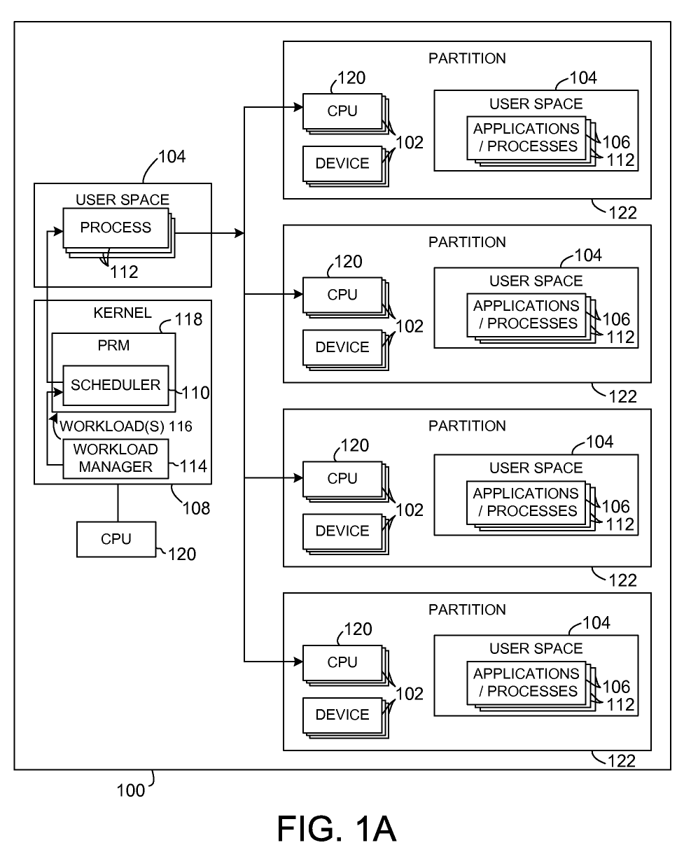

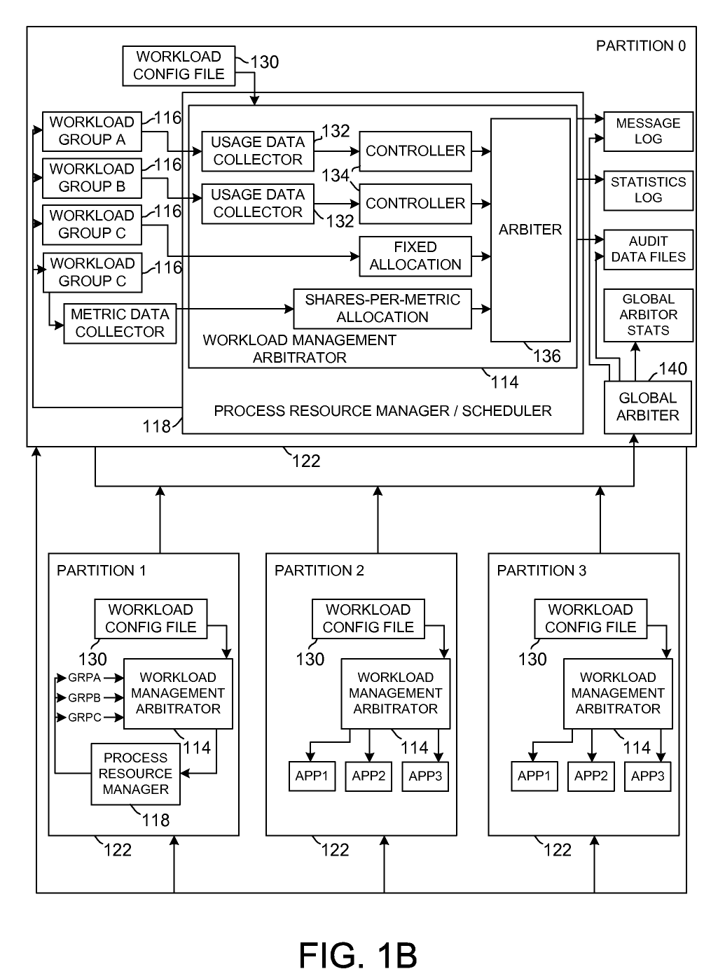

Referring to FIG. 1A, a schematic block diagram depicts an embodiment of a computing system 100 that performs kernel-based workload management. The illustrative computing system 100 includes multiple resources 102, such as processing resources. The computing system 100 has a user space 104 for executing user applications 106 and a kernel 108 configured to manage the resources 102 and communicate between the resources 102 and the user applications 106. A process scheduler 110 executes from the kernel 108 and schedules processes 112 for operation on the resources 102. A workload management arbitrator 114 is initiated by the process scheduler 110 and operates to allocate resources 102 and manage application performance for one or more workloads 116.

Accordingly, workload management determinations are made in the process scheduler 110 which is internal to the kernel 108, as distinguished from a workload manager that runs in user space and simply uses information that is accessed from the process scheduler or the kernel.

In the illustrative embodiment, workload management processor arbitration is moved into the kernel process scheduler 110. The process scheduler 110 is responsible for determining which processes 112 attain next access to the processor.

In various embodiments, the resources 102 can include processors 120, physical or virtual partitions 122, processors allocated to multiple physical or virtual partitions 122, virtual machines, processors allocated to multiple virtual machines, or the like. In some implementations, the resources 102 can also include memory resources, storage bandwidth resource, and others.

Virtual partitions and/or physical partitions 122 can be managed to control use of processor resources 102 within a partition. Workload management tasks can include coordination of movement of processors 120 between the partitions and the control of process scheduling once a processor is applied to the partition within which the processor is assigned.

The kernel scheduler 110 attempts to allocate the resources to the workloads on the operating system partition. If insufficient resources are available, a request for more can be made of a higher level workload manager which allocates processors between partitions. When a processor is added, the kernel based workload manager-enabled process scheduler 110 allocates the resources 102 of the newly acquired processors.

The workload management arbitrator 114 queries system components to determine consumption of resources 102 by the workloads 116, and adjusts allocation of resources 102 according to consumption. Workload management is performed by accessing the system 100 to determine which resources 102 are consumed by various processes 112 and then adjusting entitlement or allocation of the processes 112 to the resources 102. For example, if four instances of a program are running, workload management determines how much resource is allocated to each of the instances and adjustments are made, if appropriate.

In various embodiments, the process scheduler 110 can perform several functions, for example determining when one process has completed an execution cycle on the resource so that the processes can be swapped out in favor of a next process. Many process scheduler tasks can determine how to perform such swapping. The process scheduler 110 can also enforce process priority which is adjusted over time based on how long or frequently a process runs, when the process last ran, or how long the process waited in a run queue. Information is analyzed by the process scheduler 110 to ensure a process is allocated sufficient resources.

The process scheduler 110 and workload management arbitrator 114 can operate cooperatively in the kernel 108 during execution of a context switch from a first process to a second process by the process scheduler 110. The workload management arbitrator 114 monitors resource consumption at the context switch. Workload monitoring performed in the process scheduler 110 internal to the kernel 108 enables checking or monitoring every time a context switch is made from one process to the next and a decision is made as to which process should next have access to resources 102.

The workload management arbitrator 114 acts to increase time granularity of workload management arbitration to the time granularity of context switching in the process scheduler 110. Associating workload management with the process scheduler 110 and the kernel 108 enables a much more granular control over the amount of workload allocated between processes 112 since workload is allocated at the time context is switched between processes. The typical technique of sampling at wakeup intervals has difficulty addressing spikes in resource consumption since such spikes have often ended before the next sampling cycle occurs. In contrast, associating workload management with process scheduling in the kernel 108 enables much more rapid adjustment

The workload management arbitrator 114 can be configured to determine workload service level objectives (SLOs) and business priorities while the kernel process scheduler 110 schedules processes at least partly based on the determined workload SLOs and business priorities.

The process scheduler 110 and workload management arbitrator 114 can also act cooperatively in the kernel 108 to scheduling processes in the kernel process scheduler 110 according to run queue standing and process priority in combination with workload management service level objectives (SLOs) and business priorities.

The computing system 100 can also include a process resource manager (PRM) 118 that controls the amount of a resource 102 that can be consumed of the various resources 102. The process scheduler 110 and workload management arbitrator 114 can execute cooperatively in the kernel 108 to schedule processes 112 based on one or more workload management allocation techniques.

In various embodiments, the process scheduler 110 can perform several functions, for example determining when one process has completed an execution cycle on the resource so that the processes can be swapped out in favor of a next process. Many process scheduler tasks can determine how to perform such swapping. The process scheduler 110 can also enforce process priority which is adjusted over time based on how long or frequently a process runs, when the process last ran, or how long the process waited in a run queue. Information is analyzed by the process scheduler 110 to ensure a process is allocated sufficient resources.

The process scheduler 110 and workload management arbitrator 114 can execute in combination in the kernel 108 to schedule processes 112 in the kernel process scheduler based on one or more workload management allocation techniques. The process scheduler 110 and workload management arbitrator 114 can be initialized or set up either individually or in combination to select a suitable workload management allocation and process selection based on characteristics of resources in the system, characteristics of the application or applications performed, desired performance, and others. For example, processor resources can be allocated based on measured workload utilization.

Workload management can be based on a metric. Metrics can be operating parameters such as transaction response time or run queue length. Workload management can have the ability to manage workloads toward a response time goal which can be measured and analyzed as a metric. Thus, processor resources can also be allocated based on a metric such as transaction response time, run queue length, other response time characteristics, and others. Processor resources allocated to a workload can be resized in an automated fashion, without direct action by a user. Similarly, virtual partitions and/or physical partitions can be resized using an automated technique. Other resource allocations can be made as is appropriate for particular system configurations, applications, and operating conditions.

Also in a multiple processor system, the process scheduler 110 and workload management arbitrator 114 can detect an idle condition of a processor resource and access a run queue of a different processor and steal a thread or a process from the run queue of other processor because the other processor is busy and the idle one is not. Thus, process resources can be shared and/or borrowed among multiple workloads 116.

In an illustrative embodiment, the process scheduler 110 and workload management arbitrator 114 execute in combination to determine, based on the response time of an application, whether process priority is to be modified. For example if the response time of a high priority application is inadequately supported, the process scheduler 110 when swapping out one process out in favor of another process can give preference to any threads from the high priority application that is not meeting goals.

The process scheduler 110 and workload management arbitrator 114 execute in the kernel 108 so that processes are scheduled in the kernel according to information determined by workload management operations. For example, coordination of the process scheduler 110 and workload management arbitrator 114 in the kernel enables priority of a process to be raised based on response time of an application.

In a condition that response time of a high priority application is not attaining preselected goals, the process scheduler 110 and workload manager arbitrator 114 can interact so that the process scheduler, when ready to swap a process out and another process, can give preference to any threads from the application that is not meeting goals.

Incorporating workload management into the kernel 108 in association with the process scheduler 110 enables a substantial reduction in the delay for addressing a spike in demand for resources 102.

Referring to FIG. 1B, a schematic process flow diagram illustrates data structures and data flow of an embodiment of a workload management arbitrator 114. Workloads 116 and/or workload groups and associated goal-based or shares-based service level objectives (SLOs) are defined in the workload management configuration file 130. The workload management configuration file 130 also includes path names for data collectors 132. The workload management arbitrator 114 reads the configuration file 130 and starts the data collectors 132.

For an application with a usage goal, workload management arbitrator 114 creates a controller 134. The controller 134 is an internal component of workload management arbitrator 114 and tracks actual CPU usage or utilization of allocated CPU resources for the associated application. No user-supplied metrics are required. The controller 134 requests an increase or decrease to the workload's CPU allocation to achieve the usage goal.

For an application that runs with a metric goal, a data collector 132 reports the application's metrics, for example, transaction response times for an online transaction processing (OLTP) application.

For each metric goal, workload management arbitrator 114 creates a controller 134. A data collector 132 is assigned to track and report a workload's performance and the controllers 134 receive the metric from a respective data collector 132. The workload management arbitrator 114 compares the metric to the metric goal to determine how a workload's application is performing. If the application is performing below expectations, the controller 134 requests an increase in CPU allocations for the workload 116. If the application performs above expectations, the controller 134 can request a decrease in CPU allocations for the workload 116.

For applications without goals, workload management arbitrator 114 requests CPU resources based on the CPU shares requested in the SLO definitions. Requests can be for fixed allocations or for shares-per-metric allocations with the metric supplied from a data collector 132.

An arbiter 136 can be an internal module of workload management arbitrator 114 and collects requests for CPU shares. The requests originate from controllers 134 or, if allocations are fixed, from the SLO definitions. The arbiter 136 services requests based on priority. If resources 102 are insufficient for every application to meet the goals, the arbiter 136 services the highest priority requests first.

For managing resources within a single operating system instance, workload management arbitrator 114 creates a new process resource manager (PRM) configuration 118 that applies the new CPU for the various workload groups.

For managing CPU (cores) resources 102 across partitions, the workload management process flow is duplicated in each partition. The workload manager instance in each partition regularly requests from a workload management global arbiter 140 a predetermined number of cores for the partition. The global arbiter 140 uses the requests to determine how to allocate cores to the various partitions and to adjust each partition's number of cores to better meet the SLOs in the partition.

For partitions, creation of workloads or workload groups can be omitted by defining the partition and applications that run on the partition as the workload as shown in partition 2 142 and partition 3 144.

FIG. 1B generally shows an approximation of workload management structures that can be moved to the kernel. In an illustrative embodiment, portions of the workload management arbitrator 114 that are moved into the kernel 108 include the data collectors 132, a controller 134, and the arbiter 136. Other configurations can include different portions of workload management functionality within the kernel 108, depending on desired functionality and application characteristics.

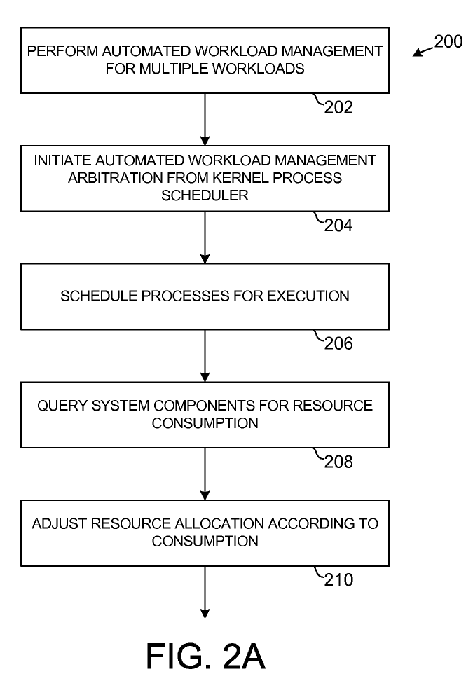

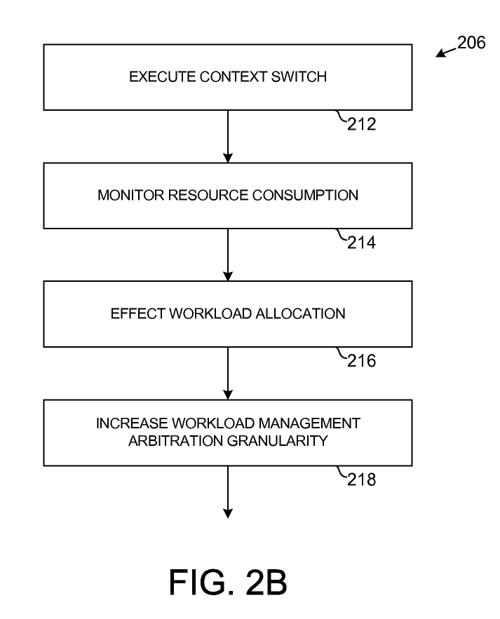

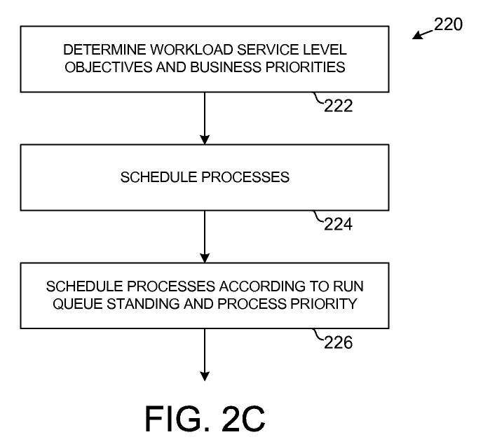

Referring to FIGS. 2A through 2C, multiple flow charts illustrate one or more embodiments or aspects of a method for managing workload in a computing system. Referring to FIG. 2A, the workload management method 200 comprises performing 202 automated workload management arbitration for multiple workloads executing on the computing system and initiating 204 the automated workload management arbitration from a process scheduler in a kernel.

The process scheduler schedules 206 processes for execution in the computer system, for example, by querying 208 system components to determine consumption of resources by the workload and adjusting 210 allocations of resources according to the determined resource consumption.

Actions of scheduling processes in the kernel process scheduler can include arbitration of workload management internal to the kernel.

As depicted in FIG. 2B, the process scheduler executes 212 a context switch from one process to another and monitors 214 resource consumption in the kernel level process at the context switch, thereby effecting 216 the allocation of workload made by the workload manager.

By operating from the kernel, the time granularity of workload management arbitration is increased 218 to the time granularity of context switching in the process scheduler.

As shown in FIG. 2C, an embodiment workload management method 220 can determine 222 workload service level objectives (SLOs) and business priorities, and schedule 224 processes in the kernel process scheduler at least partly based on the determined workload SLOs and business priorities.

In some embodiments, processes can be scheduled 226 according to run queue standing and process priority in combination with workload management service level objectives (SLOs) and business priorities.

Processes can be scheduled based on one or more considerations of workload management selected from multiple such considerations. For example, processor resources can be allocated based on measured workload utilization, response time, and others. Also processor resources can be allocated based on a metric such as a transaction response time metric, a run queue length metric, a response time metric, and many other metrics. Processor resources can be shared or borrowed among multiple workloads. Similarly, processor resources that are allocated to a workload can be resized, or virtual partitions and/or physical partitions can be resized using automated techniques in which resizing is made in response to sensed or measured conditions, and not in response to user direction.

The illustrative computer system 100 and associated operating methods 200, 210, and 220 increase the rate at which workload management algorithms can be used to reallocate resources between workloads.

The process scheduler 110 continually selects from among multiple processes 112 to determine which process is to run at a context switch. Generally the determination is made based on considerations such as process priority, run queue position, time duration of a process on the queue, and many others. In the illustrative embodiments, workload management considerations are added to the analysis of the process scheduler 110 so that workload management priorities for items on the run queue are also evaluated. Thus a process that is lower on the run queue but has higher priority according to workload management considerations can be selected next for execution to enable the associated application to meet workload management goals.

The illustrative computing system 100 and associated operating methods 200, 210, and 220 can be implemented in combination with various processes, utilities, and applications. For example workload management tools, global workload management tools, process resource managers, secure resource partitions, and others can be implemented as described to improve performance.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, functionality, values, process variations, sizes, operating speeds, and the like. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. A method for managing workload in a computing system comprising:
performing automated workload management arbitration for a plurality of workloads executing on the computing system; and
initiating the automated workload management arbitration from a process scheduler in a kernel.

2. The method according to claim 1 further comprising:
scheduling processes for execution in the computer system using the kernel process scheduler comprising:
querying system components for determining consumption of resources by the workload plurality; and
adjusting allocation of resources according to the determined resource consumption.

3. The method according to claim 1 further comprising:
executing a context switch from a first process to a second process in the process scheduler in the kernel; and
monitoring resource consumption in the kernel level process at the context switch.

4. The method according to claim 1 further comprising:
increasing time granularity of workload management arbitration to the time granularity of context switching in the process scheduler.

5. The method according to claim 1 further comprising:
determining workload service level objectives (SLOs) and business priorities; and
scheduling processes in the kernel process scheduler at least partly based on the determined workload SLOs and business priorities.

6. The method according to claim 1 further comprising:
scheduling processes in the kernel process scheduler according to run queue standing and process priority in combination with workload management service level objectives (SLOs) and business priorities.

7. The method according to claim 1 further comprising:
scheduling processes in the kernel process scheduler according to at least one workload management allocation selected from a group consisting of:
allocating processor resources based on measured workload utilization;
allocating processor resources based on a metric;
allocating processor resources based on a transaction response time metric;
allocating processor resources based on a run queue length metric;
allocating processor resources based on response time;
sharing and/or borrowing of processor resources among workloads;
automatedly resizing processor resources allocated to a workload; and
automatedly resizing virtual partitions and/or physical partitions.

8. The method according to claim 1 further comprising:
scheduling processes in the kernel process scheduler comprising arbitrating workload management internal to the kernel.

9. A computing system comprising:
a plurality of resources;
a user space operative to execute user applications;
a kernel operative to manage the resource plurality and communication between the resource plurality and the user applications;
a process scheduler configured to execute in the kernel and operative to schedule processes for operation on the resource plurality; and
a workload management arbitrator configured for initiation by the process scheduler and operative to allocate resources and manage application performance for at least one workload.

10. The computing system according to claim 9 further comprising:
a process resource manager (PRM) operative to control a resource amount for consumption in the resource plurality.

11. The computing system according to claim 9 further comprising:
the resource plurality comprising a plurality of processors, a plurality of physical partitions, a plurality of processors allocated to multiple physical partitions, a plurality of virtual partitions, a plurality of processors allocated to multiple virtual partitions, a plurality of virtual machines, a plurality of processors allocated to multiple virtual machines, memory resource, storage bandwidth resource, and network bandwidth resource.

12. The computing system according to claim 9 further comprising:
the workload management arbitrator operative to query system components for determining consumption of resources by the workload plurality, and adjust allocation of resources according to the determined resource consumption.

13. The computing system according to claim 9 further comprising:
the process scheduler and workload management arbitrator operative in combination in the kernel for executing a context switch from a first process to a second process by the process scheduler and monitoring resource consumption in the kernel level process at the context switch.

14. The computing system according to claim 9 further comprising:
the workload management arbitrator configured for increasing time granularity of workload management arbitration to the time granularity of context switching in the process scheduler.

15. The computing system according to claim 9 further comprising:
the workload management arbitrator configured for determining workload service level objectives (SLOs) and business priorities, and scheduling processes in the kernel process scheduler at least partly based on the determined workload SLOs and business priorities.

16. The computing system according to claim 9 further comprising:
the process scheduler and workload management arbitrator operative in the kernel for scheduling processes in the kernel process scheduler according to run queue standing and process priority in combination with workload management service level objectives (SLOs) and business priorities.

17. The computing system according to claim 9 further comprising:
the process scheduler and workload management arbitrator operative in the kernel for scheduling processes in the kernel process scheduler according to at least one workload management allocation selected from a group consisting of:
allocating processor resources based on measured workload utilization;
allocating processor resources based on a metric;
allocating processor resources based on a transaction response time metric;
allocating processor resources based on a run queue length metric;
allocating processor resources based on response time;
sharing and/or borrowing of processor resources among workloads;
automatedly resizing processor resources allocated to a workload; and
automatedly resizing virtual partitions and/or physical partitions.

18. The computing system according to claim 9 further comprising:
the process scheduler and workload management arbitrator operative in the kernel for scheduling processes in the kernel process scheduler comprising arbitrating workload management internal to the kernel.

19. An article of manufacture comprising:
a controller usable medium having a computable readable program code embodied therein for managing workload in a computing system, the computable readable program code further comprising:
a code adapted to cause the controller to perform automated workload management arbitration for a plurality of workloads executing on the computing system; and
a code adapted to cause the controller to initiate the automated workload management arbitration from a process scheduler in a kernel.

20. A computing system comprising:
means for managing workload in a computing system;
means for performing automated workload management arbitration for a plurality of workloads executing on the computing system; and
means for initiating the automated workload management arbitration from a process scheduler in a kernel.
